(19) United States
(12) Patent Application Publication
(10) Pub. No.: US 2008/0008919 A1
(43) Pub. Date: Jan. 10, 2008

(54) MEMBRANE ELECTRODE ASSEMBLY AND FUEL CELL USING SAME

(76) Inventors: Takaaki Mizukami, Hitachi (JP); Jinichi Imahashi, Hitachi (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/626,884

(22) Filed: Jan. 25, 2007

(30) Foreign Application Priority Data
Jul. 5, 2006 (JP) 2006-185076

(51) Int. Cl. H01M 8/10

(52) U.S. Cl. 429/30

(57) ABSTRACT

A fuel cell comprising a unit cell, in which an anode for oxidizing a fuel and a cathode for reducing oxygen disposed to sandwich a solid polymer electrolyte membrane; the anode is an electrode catalyst layer formed by mixing microbubbles controlled in particle diameter to an electrode catalyst slurry including the anode materials; and the cathode is an electrode catalyst layer formed by mixing microbubbles controlled in particle diameter to an electrode catalyst slurry including the cathode materials, can achieve a high power generation by controlling the capillary structure of the electrode catalyst layer, by improving the diffusion of matters to be consumed and the rejection of created water in the electrode catalyst layer, and by enhancing use efficiency of the catalyst metal.

This patent application is based on Japanese patent application No. 2006-185076 filed on Jul. 5, 2006, the entire contents of which are incorporated herein by reference.

### BACKGROUND OF THE INVENTION

1. Filed of the Invention

The invention relates to a novel membrane electrode assembly and a fuel cell using the same.

2. Description of the Related Art

A structural feature of a polymer electrolyte fuel cell is generally a membrane electrode assembly (MEA) comprising a solid polymer electrolyte membrane, an anode (fuel electrode) disposed on one surface of the solid polymer electrolyte membrane, and a cathode (oxidant electrode) disposed on another surface of the solid polymer electrolyte membrane, wherein the anode and the cathode are composed of carrier carbon layers having a catalyst metal (hereinafter generically called as electrode catalyst layers). Further, on the outside of each electrode catalyst layer which is an opposite side from the side of the solid polymer electrolyte membrane and is not in contact with the membrane, a diffusion layer is disposed for smooth diffusion of hydrogen or methanol as a fuel, and air or oxygen as an oxidant.

A principle of power generation of in a fuel cell is as follows. For example, a hydrogen gas used as a fuel separates into hydrogen ions and electrons on the anode, and these hydrogen ions move to the cathode side in the electrolyte membrane while the electrons move via an external circuit to the cathode side. On the cathode, an oxygen gas in the air used as an oxidant gas, the electrons, and the hydrogen ions react to create water according to the reaction expressed by the following equations:

| | |
|---|---|
| Anode reaction | H₂ → 2H⁺ + 2e⁻ |
| Cathode reaction | ½O₂ + 2H⁺ + 2e⁻ → H₂O |
| Total reaction | H₂ + ½O₂ → H₂O |

Therefore, in the polymer electrolyte fuel cell, smooth diffusion and permeation of hydrogen or oxygen into the catalyst are required. Furthermore, the water created due to the power generation must be rejected quickly so as not to inhibit the diffusion and permeation of hydrogen or oxygen into the catalyst. For this reason, in the polymer electrolyte fuel cell, controlling the gases and the created water in the electrode catalyst layers is a very important technical issue.

A conventional fuel cell is formed such that each electrode catalyst layer has a capillary structure with a three-dimensional network in order to improve efficiencies of the gas diffusion and the water rejection. As a method for forming the capillary structure in the electrode catalyst layer, application of a capillary forming agent or the like to the layer is developed (e.g., see JP-A-1994-203852).

However, the conventional method for forming the capillary structure has a problem as follows. The formation method using a capillary forming agent requires a step of removing the capillary forming agent from the electrode catalyst layer, after forming the electrode catalyst layer. As the capillary forming agents, e.g., metal powders or solids decomposable at low temperatures are used. Furthermore, as a method for removing the capillary forming agent, e.g., a treatment such as dissolution of a metal powder by an acid, or decomposition of solids by a heat treatment is conducted. When such a treatment for removing the capillary forming agent is carried out, the fuel cell performances are easy to be degraded due to the reduction of the proton conductivity caused by the accumulation of metal ions in the solid polymer electrolyte membrane, or the degeneration of the solid polymer electrolyte membrane caused by the heat treatment. Therefore, the manufacturing process of an electrode catalyst layer becomes complicated, resulting in an increase of the manufacturing cost.

On the other hand, the following method is also considered. By means of using a carrier carbon with a developed stereo-structure or with a large aspect ratio, the capillary structure can be formed in the electrode catalyst layer.

However, when the carrier carbon with such a shape is used, although the capillary structure of the electrode catalyst layer can be controlled, it is difficult to uniformly mix the carrier and the polymer electrolyte to be added in the electrode catalyst layer. As a result, the use efficiency of the catalyst metal decreases, which reduces the fuel cell performances. Furthermore, selection of the carrier is restrained.

### SUMMARY OF THE INVENTION

The present invention has been completed based on the following finding: in the capillary structure of the electrode catalyst layer, control of the capillary diameter distribution within a specific range improves efficiencies of the gas diffusion and the water rejection.

It is an object of the present invention to provide a membrane electrode assembly (MEA) and a fuel cell using the same in which the diffusion of matters to be consumed and the rejection of created water in the electrode catalyst layer have been improved, and thereby the use efficiency of the catalyst metal has been enhanced, and a high power generation can be achieved even in the operation at a high current density.

(1) In accordance with a first aspect of the present invention, a unit cell of a fuel cell comprises:
an anode for oxidizing a fuel and a cathode for reducing oxygen disposed to sandwich a solid polymer electrolyte membrane; the anode is an electrode catalyst layer formed by mixing micro-bubbles controlled in particle diameter to an electrode catalyst slurry including the anode materials; and the cathode is an electrode catalyst layer formed by mixing microbubbles controlled in particle diameter to an electrode catalyst slurry including the cathode materials.

In the above invention (1), the following modifications and changes can be made.

(i) In the electrode catalyst layers, the peak diameter D and the full width at half maximum of the peak σ of the particle diameter distribution of the microbubbles to be mixed in the electrode catalyst slurry satisfy a relationship of σ≦1.5 D.

(ii) In the electrode catalyst layers, the peak diameter D of in particle diameter distribution of the microbubbles to be mixed in the electrode catalyst slurry is within a range of 0.01 to 100 μm.

(iii) A fuel cell using the unit cell according to the first aspect of the present invention.

(2) In accordance with a second aspect of the present invention, a unit cell of a fuel cell comprises:
electrode catalyst layers with a capillary structure disposed to sandwich a solid polymer electrolyte membrane having an ion conductivity; and
in the electrode catalyst layers, the peak diameter D and the full width at half maximum of the peak σ of the capillary diameter distribution satisfy a relationship of σ≦1.5 D.

In the above invention (2), the following modifications and changes can be made.

(iv) In the electrode catalyst layers, the peak diameter D of the capillary diameter distribution is within a range of 0.01 to 100 μm.

(v) A fuel cell using the unit cell according to the second aspect of the present invention.

(3) In accordance with a third aspect of the present invention, a membrane electrode assembly (MEA) is formed by coating an electrode catalyst slurry on a solid polymer electrolyte membrane having an ion conductivity or by bonding a gas diffusion layer on which an electrode catalyst slurry is coated with a solid polymer electrolyte membrane having an ion conductivity; and
the electrode catalyst slurry includes microbubbles of which the peak diameter D and the full width at half maximum of the peak σ of the particle diameter distribution satisfy the relationship of σ≦1.5 D.

In the above invention (3), the following modifications and changes can be made.

(vi) In the electrode catalyst slurry, the peak diameter D of the microbubble diameter distribution is within a range of 0.01 to 100 μM.

(vii) A fuel cell using the MEAs according to the third aspect of the present invention.

The present invention can provide a membrane electrode assembly and a fuel cell using the same achieving a high power generation by controlling the capillary structure of the electrode catalyst layer, by improving the diffusion of matters to be consumed and the rejection of created water in the electrode catalyst layer, and by enhancing use efficiency of the catalyst metal.

### BRIEF DESCRIPTION OF THE DRAWINGS

FIG. 1 is a schematic illustration of a cross sectional view showing one example of a fuel cell obtained according to the present invention;

FIGS. 2 and 3 are schematic illustrations showing one example of a MEA in accordance with an embodiment of the present invention, FIG. 2 shows the state just after coating an electrode catalyst slurry on a solid polymer electrolyte membrane, and

FIG. 3 shows the state after drying a solvent of the electrode catalyst slurry;

FIG. 4 is a diagram showing the particle diameter distribution of bubbles to be mixed in the electrode catalyst slurry in the cases of Example 2 and Comparative example 2;

FIG. 5 is a diagram showing the particle diameter distribution of bubbles to be mixed in the electrode catalyst slurry in the cases of Example 2 and Comparative example 3; and

FIG. 6 is a diagram showing the results of power generation test of the fuel cells manufactured by using MEAs of Examples 1 and 2, and Comparative examples 1 to 3.

### DETAILED DESCRIPTION OF THE PREFERRED EMBODIMENTS

Embodiments in accordance with the present invention will be described by reference to the accompanying drawings.

In the following embodiments, a hydrogen gas is used as a fuel, and an air is used as an oxidant gas. It is also acceptable that a methanol aqueous solution is used as a fuel and that an oxygen gas is used as an oxidant gas.

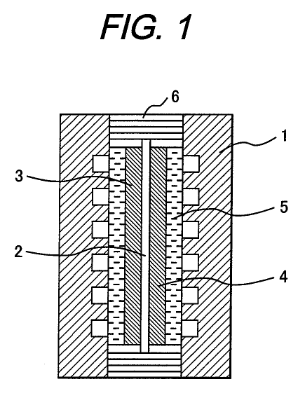

FIG. 1 shows a schematic illustration of a cross sectional view showing one example of a fuel cell obtained according to the present invention. As shown in FIG. 1, reference numerals of 1 to 6 show a separator, a solid polymer electrolyte membrane, an anode, a cathode, a diffusion layer, and a gasket, respectively.

A unit cell of the fuel cell comprises the solid polymer electrolyte membrane 2, the anode 3 disposed on one surface of the solid polymer electrolyte membrane 3, and the cathode 4 disposed on another surface of the solid polymer electrolyte membrane 2. The thing assembled and bonded above components integrally is referred to as MEA (Membrane Electrode Assembly). Further, the anode 3 and the cathode 4 are each generically referred to as an electrode catalyst layer.

It is necessary that the separator 1 has an electric conductivity. As a material thereof, a dense graphite plate, a mold plate obtained by molding a carbon material such as graphite or carbon black with a resin, or a metal material with excellent corrosion resistance such as a stainless steel or a titanium is preferably used.

Furthermore, it is also desirably that the surface of the separator 1 is subjected to a surface treatment such as noble metal plating or coating with an electrically conductive paint excellent in the corrosion resistance and the heat resistance. In the portions of the separators 1 facing the anode 3 and the cathode 4, grooves are formed respectively. Thus, a fuel gas or a liquid fuel is fed to the anode 3 along the grooves, and an air or an oxygen is fed to the cathode 4 in the same manner.

When a hydrogen gas is used as a fuel, and an air is used as an oxidant gas, at the anode 3 and the cathode 4, the reactions expressed by the formulae (1) and (2) occur, respectively. Thus, electricity can be generated.

H₂→2H⁺+2e⁻ (1)

O₂+4H⁺+4e⁻→2H₂O (2)

On the other hand, when a methanol aqueous solution (liquid) is used as a fuel, the reaction expressed by the formula (3) occurs at the anode 3. Thus, electricity can be generated.

CH₃OH+H₂O→CO₂+6H⁺+6e⁻

The protons (hydrogen ions) generated at the anode 3 expressed by the formula (1) or (3) move to the cathode 4 through the solid polymer electrolyte membrane 2.

For the diffusion layer 5, water repellent treated carbon paper or carbon cloth is used.

Any material is acceptable for the gasket 6 so long as it has an insulating property and a gastight property, particularly, has less permeability of a hydrogen gas therethrough. For example, butyl rubber, Viton rubber (Viton: registered trademark), or ethylene propylene diene terpolymer (EPDM) rubber can be used.

For the solid polymer electrolyte membrane 2 and the solid polymer electrolyte contained in the electrode catalyst layers (the anode 3 and the cathode 4) in the present invention, polymer materials showing a hydrogen ion conductivity are used. Examples thereof may include sulfonated or alkylene sulfonated fluorine type polymers and polystyrenes (e.g., perfluorocarbon type sulfonic acid resins and polyperfluorostyrene type sulfonic acid resins). Other than these, polysulfones, polyether sulfones, polyether ether sulfones, polyether ether ketones, and materials obtained by sulfonating hydrocarbon type polymers are also acceptable.

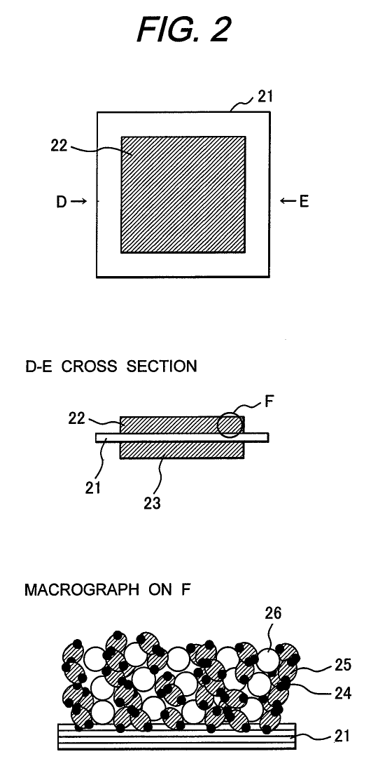

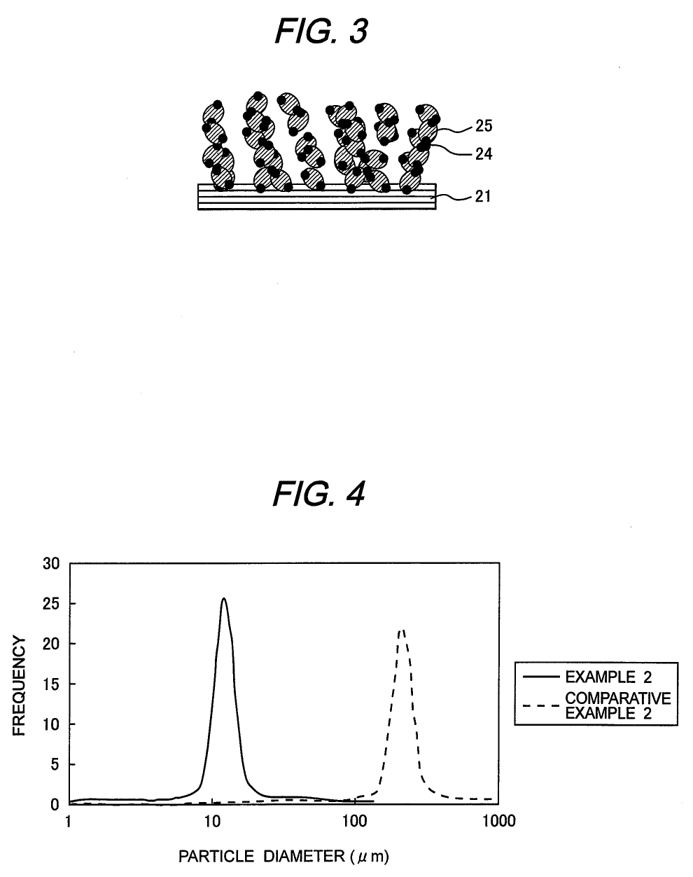

FIGS. 2 and 3 are schematic diagrams showing one example of the MEA in accordance with a preferred embodiment of the present invention. FIG. 2 shows the state just after coating an electrode catalyst slurry on a solid polymer electrolyte membrane, and FIG. 3 shows the state after drying a solvent of the electrode catalyst slurry. As shown in FIGS. 2 and 3, reference numerals of 21 to 26 represent a solid polymer electrolyte membrane, a cathode, an anode, a catalyst metal, a carrier carbon, and a bubble controlled in particle diameter.

As with this embodiment, bubbles controlled in particle diameter are mixed into at least one electrode catalyst slurry of the cathode 4 or the anode 3, thereby the capillary structure of the electrode catalyst layer can be controlled. Thus, the diffusion of matters (gases and liquids) to be consumed and the rejection of created water in the electrode catalyst layer are improved. As a result, it is possible to provide a membrane electrode assembly having a high use efficiency of the catalyst metal and a high power generation.

For the catalyst metal 24, it is desired to use at least platinum in the cathode and at least an alloy containing platinum or ruthenium in the anode. Thereby, a high voltage can be generated, and a voltage decrease due to the catalyst poisoning of carbon monoxide (CO) or the like is small. The catalyst metals are not particularly limited thereto. In order to stabilize and achieve a longer life of the electrode catalyst, it is possible to use catalysts containing third components selected from iron, tin, and/or rare earth elements to the noble metal components.

Further, for the carrier carbon 25, carbon black with a large specific surface area is desirable in order to hold the catalyst metal 24 in the form of fine particles. The specific surface area desired is within a range of 50 to 1500 m²/g.

One example of the manufacturing method of the MEA in a preferred embodiment will be described below.

Firstly, a carrier carbon carrying a catalyst metal thereon (which is hereinafter simply referred to as an electrode catalyst), a solid polymer electrolyte and a solvent for dissolving the solid polymer electrolyte are mixed to make an electrode catalyst slurry.

Then, the electrode catalyst slurry is passed through the microbubble generator as shown in, e.g., JP-A-2000-447, “Swirling type microbubble generator”. Thereby, microbubbles controlled in particle diameter are mixed therein.

Then, by a screen printing method or an applicator method, the electrode catalyst slurry is coated on a release film such as a tetrafluoroethylene film to form a precursor of the electrode catalyst layer. The electrode catalyst layer precursors are bonded on the both sides of the solid polymer electrolyte membrane by a hot press method. Alternatively, a solution of the solid polymer electrolyte membrane is added as an adhesive between each electrode catalyst layer precursor and the solid polymer electrolyte membrane for bonding. As a result, the MEA in this embodiment can be manufactured.

Incidentally, the MEA in this embodiment can be also manufactured even by the following procedure. A liquid refractory (less soluble) to the solid polymer electrolyte and the solvent for dissolving the solid polymer electrolyte is mixed therein in place of the bubbles controlled in particle diameter. Thus, an electrode slurry including a fine liquid particle controlled in the diameter is prepared by means of an emulsification apparatus.

Next, another example of the manufacturing method of the MEA in accordance with this embodiment will be described below.

In the same manner as described above, an electrode catalyst, a solid polymer electrolyte and a solvent for dissolving the solid polymer electrolyte are mixed to make an electrode catalyst slurry.

Then, the electrode catalyst slurry is passed through the microbubble generator as shown in, e.g., JP-A-2000-447, “Swirling type microbubble generator”. Thereby, microbubbles controlled in particle diameter are mixed therein.

Then, by a screen printing method or an applicator method, the electrode catalyst slurry is coated on a release film such as a tetrafluoroethylene film to form a precursor of the electrode catalyst layer. The electrode catalyst layer precursor is bonded on one side of the diffusion layer by a hot press method. Alternatively, the electrode catalyst slurry is directly coated on the diffusion layer, and then, dried.

Then, the diffusion layers each having the electrode catalyst layer precursor are bonded onto the both sides of the solid polymer electrolyte membrane by a hot press method. Alternatively, a solution of the solid polymer electrolyte membrane is added as an adhesive between each electrode catalyst layer precursor and the solid polymer electrolyte membrane for bonding. As a result, the MEA in this embodiment can be manufactured.

Incidentally, the MEA in this embodiment can be also manufactured even by the following procedure. A liquid refractory (less soluble) to the solid polymer electrolyte and the solvent for dissolving the solid polymer electrolyte is mixed therein in place of the bubbles controlled in particle diameter. Thus, an electrode slurry including a fine liquid particle controlled in the diameter is prepared by means of an emulsification apparatus.

Then, another example of the manufacturing method of the MEA in accordance with this embodiment will be described below.

In the same manner as described above, an electrode catalyst, a solid polymer electrolyte and a solvent for dissolving the solid polymer electrolyte are mixed to make an electrode catalyst slurry.

Then, the electrode catalyst slurry is passed through the microbubble generator as shown in, e.g., JP-A-2000-447, “Swirling type microbubble generator”. Thereby, microbubbles controlled in particle diameter are mixed therein.

Then, with a spray method, a compression molding method, a growth method, or the like, the electrode catalyst in the electrode catalyst slurry is granulated to a predetermined particle diameter.

Then, a solvent is added and mixed to the granulated electrode catalyst to make a slurry of the granulated electrode catalyst.

Then, the granulated electrode catalyst slurry is coated on a release film such as a tetrafluoroethylene film by a screen printing method or an applicator method to form an electrode catalyst layer precursor.

Then, the electrode catalyst layer precursors are bonded on the both sides of the solid polymer electrolyte membrane by a hot press method. Alternatively, a solution of the solid polymer electrolyte membrane is added as an adhesive between each electrode catalyst layer precursor and the solid polymer electrolyte membrane for bonding. As a result, the MEA in this embodiment can be manufactured.

Incidentally, the MEA in this embodiment can be also manufactured even by the following procedure. A liquid refractory (less soluble) to the solid polymer electrolyte and the solvent for dissolving the solid polymer electrolyte is mixed therein in place of the bubbles controlled in particle diameter. Thus, an electrode slurry including a fine liquid particle controlled in the diameter is prepared by means of an emulsification apparatus.

Examples of the invention will be specifically described below, but the invention is not limited by these examples.

### EXAMPLE 1

For an anode and a cathode, carbon black carrying the platinum in an amount of 50 mass % is used as an electrode catalyst. The electrode catalyst is added to 5 mass % Nafion solution (manufactured by Aldrich) (Nafion: registered trademark, manufactured by DuPont Co.), in which a mass ratio of the electrode catalyst and the Nafion solution is 1:9. Mixing the blend and vaporizing the solvent are carried out, thereby to prepare a viscous electrode catalyst slurry.

Then, the viscous electrode catalyst slurry is passed through the microbubble generator as shown in, e.g., JP-A-2000-447, “Swirling type microbubble generator”. Thus, microbubbles that is controlled in the peak diameter of about 10 μm in the particle diameter distribution are mixed therein.

The electrode catalyst slurry including the microbubbles is coated onto a diffusion layer by a screen printing method, and then the solvent of the electrode catalyst slurry is dried, thereby the electrode catalyst layer precursor is formed. The platinum content in the electrode catalyst layer is 0.5 mg/cm².

Two sheets of the diffusion layers each having the electrode catalyst precursor formed thereon are prepared. As the solid polymer electrolyte membrane, a film of Nafion 112 (registered trademark, manufactured by DuPont Co.) with a thickness of 50 μm is used. The diffusion layers each having the electrode catalyst layer precursor are bonded onto the both sides of the film of Nafion 112 by a hot press method, in which the electrode catalyst layer precursor faces to the film of Nafion 112. Thereby, the MEA of Example 1 is manufactured.

By the use of the MEA of Example 1, the fuel cell as shown in FIG. 1 is manufactured. Thus, a power generation test is conducted by using the hydrogen gas and the air under the atmospheric pressure. Conditions of the power generation test are as follows. All of the cell temperature, the cathode humidification temperature and the anode humidification temperature are set at 70° C.; and the utilization rates of the hydrogen and the air are 80% and 40%, respectively. FIG. 6 is a diagram showing the results of the power generation test of the fuel cells manufactured by using the MEAs of Examples 1 and 2, and Comparative examples 1 to 3. As shown in FIG. 6, it is confirmed that the fuel cell using the MEA of Example 1 generates a high voltage and shows sufficient performances as the MEA for a fuel cell.

### EXAMPLE 2

For an anode and a cathode, carbon black carrying the platinum in an amount of 50 mass % is used as an electrode catalyst. The electrode catalyst is added to 5 mass % Nafion solution (manufactured by Aldrich) (Nafion: registered trademark, manufactured by DuPont Co.), in which a mass ratio of the electrode catalyst and the Nafion solution is 1:9. Mixing the blend and vaporizing the solvent are carried out, thereby to prepare a viscous electrode catalyst slurry.

Then, the viscous electrode catalyst slurry is passed through the microbubble generator as shown in, e.g., JP-A-2000-447, “Swirling type microbubble generator”. Thus, microbubbles that is controlled in the peak diameter of about 10 μm in the particle diameter distribution are mixed therein.

The electrode catalyst slurry including the microbubbles is coated onto a tetrafluoroethylene sheet by a screen printing method, and then the solvent of the electrode catalyst slurry is dried, thereby the electrode catalyst layer precursor is formed. The platinum content in the electrode catalyst layer is 0.5 mg/cm².

Two sheets of the electrode catalyst layer precursors are prepared. As the solid polymer electrolyte membrane, a film of Nafion 112 (registered trademark, manufactured by DuPont Co.) with a thickness of 50 μm is used. The electrode catalyst layer precursors are bonded onto the both sides of the film of Nafion 112 by a hot press method. Thereby, the MEA of Example 2 is manufactured.

By the use of the MEA of Example 2, the fuel cell as shown in FIG. 1 is manufactured. Thus, a power generation test is conducted by using the hydrogen gas and the air under the atmospheric pressure. Conditions of the power generation test are as follows. All of the cell temperature, the cathode humidification temperature and the anode humidification temperature are set at 70° C.; and the utilization rates of the hydrogen and the air are 80% and 40%, respectively. The result of the power generation test is described together in FIG. 6. As shown in FIG. 6, it is confirmed that the fuel cell using the MEA of Example 2 generates a high voltage and shows sufficient performances as the MEA for a fuel cell.

### COMPARATIVE EXAMPLE 1

In the fabrication procedure of MEA, the step of mixing microbubbles in the electrode catalyst slurry is omitted. The other steps are conducted by the same method as in Example 2; thereby the MEA of Comparative example 1 is manufactured as follows.

For an anode and a cathode, carbon black carrying the platinum in an amount of 50 mass % is used as an electrode catalyst. The electrode catalyst is added to 5 mass % Nafion solution (manufactured by Aldrich) (Nafion: registered trademark, manufactured by DuPont Co.), in which a mass ratio of the electrode catalyst and the Nafion solution is 1:9. Mixing the blend and vaporizing the solvent are carried out, thereby to prepare a viscous electrode catalyst slurry.

The viscous electrode catalyst slurry is coated onto a tetrafluoroethylene sheet by a screen printing method, and then the solvent of the electrode catalyst slurry is dried, thereby an electrode catalyst layer precursor is formed. The platinum content in the electrode catalyst layer is 0.5 mg/cm².

Two sheets of the electrode catalyst layer precursors are prepared. As the solid polymer electrolyte membrane, a film of Nafion 112 (registered trademark, manufactured by DuPont Co.) with a thickness of 50 mm is used. The electrode catalyst layer precursors are bonded onto the both sides of the film of Nafion 112 by a hot press method. Thereby, the MEA of Comparative example 1 is manufactured.

By the use of the MEA of Comparative example 1, the fuel cell as shown in FIG. 1 is manufactured. Thus, a power generation test is conducted by using the hydrogen gas and the air under the atmospheric pressure. Conditions of the power generation test are as follows. All of the cell temperature, the cathode humidification temperature, and the anode humidification temperature are set at 70° C.; and the utilization rates of the hydrogen and the air are 80% and 40%, respectively. The result of the power generation test is described together in FIG. 6. As shown in FIG. 6, it is revealed that the fuel cell using the MEA of Comparative example 1 generates a lower voltage than those of any Examples. Further, power generation at such a high current density (about 1.4 A/cm² or more) is impossible.

### COMPARATIVE EXAMPLE 2

FIG. 4 is a diagram showing the particle diameter distribution of bubbles to be mixed in the electrode catalyst slurry in the cases of Example 2 and Comparative example 2. In the step of mixing bubbles in the electrode catalyst slurry of the fabrication procedure of MEA, the peak diameter in the particle diameter distribution of the microbubbles is controlled to about 400 μm as shown in FIG. 4. The other steps are conducted by the same method as in Example 2; thereby the MEA of Comparative example 2 is manufactured as follows.

For an anode and a cathode, carbon black carrying the platinum in an amount of 50 mass % is used as an electrode catalyst. The electrode catalyst is added to 5 mass % Nafion solution (manufactured by Aldrich) (Nafion: registered trademark, manufactured by DuPont Co.), in which a mass ratio of the electrode catalyst and the Nafion solution is 1:9. Mixing the blend and vaporizing the solvent are carried out, thereby to prepare a viscous electrode catalyst slurry.

Then, the viscous electrode catalyst slurry is passed through the microbubble generator as shown in, e.g., JP-A-2000-447, “Swirling type microbubble generator”. Thus, bubbles that is controlled in the peak diameter of about 400 μm in the particle diameter distribution are mixed therein.

The electrode catalyst slurry including the bubbles is coated onto a tetrafluoroethylene sheet by a screen printing method, and then the solvent of the electrode catalyst slurry is dried, thereby the electrode catalyst layer precursor is formed. The platinum content in the electrode catalyst layer is 0.5 mg/cm².

Two sheets of the electrode catalyst layer precursors are prepared. As the solid polymer electrolyte membrane, a film of Nafion 112 (registered trademark, manufactured by DuPont Co.) with a thickness of 50 μm is used. The electrode catalyst layer precursors are bonded onto the both sides of the film of Nafion 112 by a hot press method. Thereby, the MEA of Comparative example 2 is manufactured.

By the use of the MEA of Comparative example 2, the fuel cell as shown in FIG. 1 is manufactured. Thus, a power generation test is conducted by using the hydrogen gas and the air under the atmospheric pressure. Conditions of the power generation test are as follows. All of the cell temperature, the cathode humidification temperature and the anode humidification temperature are set at 70° C.; and the utilization rates of the hydrogen and the air are 80% and 40%, respectively. The result of the power generation test is described together in FIG. 6. As shown in FIG. 6, it is recognized that the fuel cell using the MEA of Comparative example 2 generates only a lower voltage than those of Example 1, Example 2, and Comparative example 1.

### COMPARATIVE EXAMPLE 3

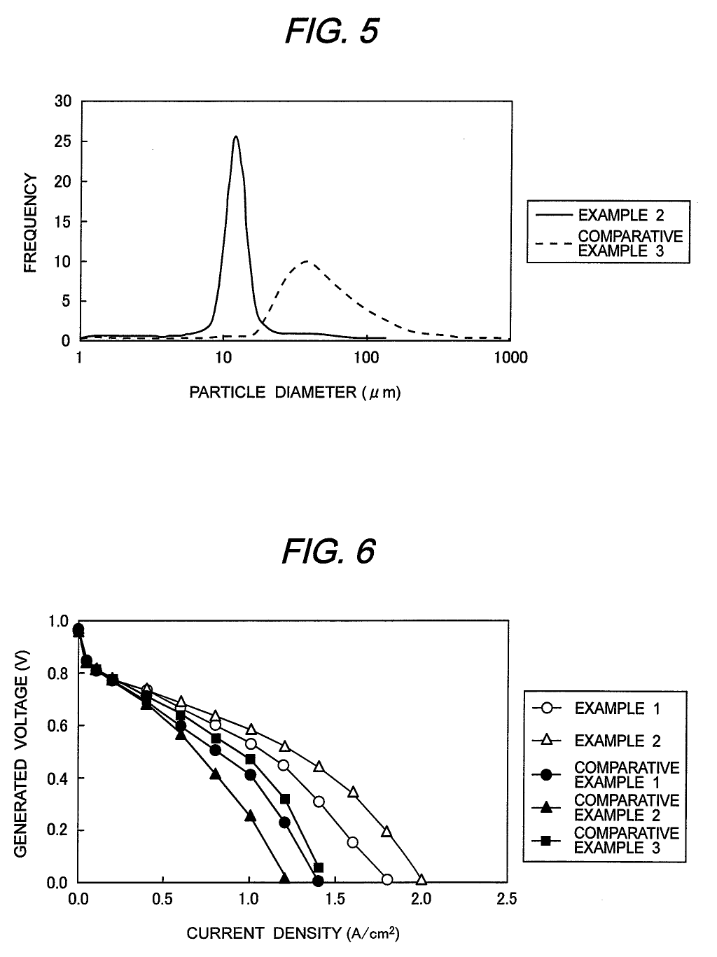

FIG. 5 is a diagram showing the particle diameter distribution of bubbles to be mixed in the electrode catalyst slurry in the cases of Example 2 and Comparative example 3. In the step of mixing bubbles in the electrode catalyst slurry of the fabrication procedure of MEA, the peak diameter in the particle diameter distribution of the microbubbles is controlled such that the peak diameter is about 30 μm, and such that the full width at half maximum of the peak is about 50 μm, as shown in FIG. 5. The other steps are conducted by the same method as in Example 2; thereby the MEA of Comparative example 3 is manufactured as follows.

For an anode and a cathode, carbon black carrying the platinum in an amount of 50 mass % is used as an electrode catalyst. The electrode catalyst is added to 5 mass % Nafion solution (manufactured by Aldrich) (Nafion: registered trademark, manufactured by DuPont Co.), in which a mass ratio of the electrode catalyst and the Nafion solution is 1:9. Mixing the blend and vaporizing the solvent are carried out, thereby to prepare a viscous electrode catalyst slurry.

Then, the viscous electrode catalyst slurry is passed through the microbubble generator as shown in, e.g., JP-A-2000-447, “Swirling type microbubble generator”. Thus, microbubbles that is controlled in the peak diameter of about 30 μm in the particle diameter distribution and in full width at half maximum of the peak of about 50 μm are mixed therein.

The electrode catalyst slurry including the microbubbles is coated onto a tetrafluoroethylene sheet by a screen printing method, and then the solvent of the electrode catalyst slurry is dried, thereby the electrode catalyst layer precursor is formed. The platinum content in the electrode catalyst layer is 0.5 mg/cm².

Two sheets of the electrode catalyst layer precursors are prepared. As the solid polymer electrolyte membrane, a film of Nafion 112 (registered trademark, manufactured by DuPont Co.) with a thickness of 50 μm is used. The electrode catalyst layer precursors are bonded onto the both sides of the film of Nafion 112 by a hot press method. Thereby, the MEA of Comparative example 3 is manufactured.

By the use of the MEA of Comparative example 3, the fuel cell as shown in FIG. 1 is manufactured. Thus, a power generation test is conducted by using the hydrogen gas and the air under the atmospheric pressure. Conditions of the power generation test are as follows. All of the cell temperature, the cathode humidification temperature and the anode humidification temperature are set at 70° C.; and the utilization rates of the hydrogen and the air are 80% and 40%, respectively. The result of the power generation test is described together in FIG. 6. As shown in FIG. 6, it is revealed that the fuel cell using the MEA of Comparative example 3 generates only a lower voltage than that of Example 2.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A unit cell of a fuel cell comprising:
an anode for oxidizing a fuel and a cathode for reducing oxygen disposed to sandwich a solid polymer electrolyte membrane; the anode is an electrode catalyst layer formed by mixing microbubbles controlled in particle diameter to an electrode catalyst slurry including the anode materials; and
the cathode is an electrode catalyst layer formed by mixing microbubbles controlled in particle diameter to an electrode catalyst slurry including the cathode materials.

2. A unit cell according to claim 1, wherein:
in electrode catalyst layers, a peak diameter D and a full width at half maximum of the peak σ of a particle diameter distribution of microbubbles to be mixed in the electrode catalyst slurry satisfy a relationship of σ≦1.5 D.

3. A unit cell according to claim 1, wherein:
in electrode catalyst layers, a peak diameter D in particle diameter distribution of microbubbles to be mixed in the electrode catalyst slurry including is within a range of 0.01 to 100 μm.

4. A fuel cell using a unit cell according to claim 1.

5. A unit cell of a fuel cell comprising:
electrode catalyst layers with a capillary structure disposed to sandwich a solid polymer electrolyte membrane having an ion conductivity; and
in the electrode catalyst layers, a peak diameter D and a full width at half maximum of the peak σ of the capillary diameter distribution satisfy a relationship of σ≦1.5 D.

6. A unit cell according to claim 5, wherein:
in electrode catalyst layers, a peak diameter D of a capillary diameter distribution is within a range of 0.01 to 100 μm.

7. A fuel cell using a unit cell according to claim 5.

8. A membrane electrode assembly comprising:
the membrane electrode assembly is formed by coating an electrode catalyst slurry on a solid polymer electrolyte membrane having an ion conductivity, or by bonding a gas diffusion layer on which an electrode catalyst slurry is coated with a solid polymer electrolyte membrane having an ion conductivity; and
the electrode catalyst slurry includes microbubbles of which a peak diameter D and a full width at half maximum of the peak σ of the particle diameter distribution satisfy the relationship of σ≦1.5 D.

9. A membrane electrode assembly according to claim 8, wherein:
in a electrode catalyst slurry, a peak diameter D of the microbubble diameter distribution is within a range of 0.01 to 100 μm.

10. A fuel cell using a membrane electrode assembly according to claim 8.
